(19) United States
(12) Patent Application Publication
(10) Pub. No.: US 2026/0210405 A1
(43) Pub. Date: Jul. 23, 2026

(54) BEARING ASSEMBLY, FOR EXAMPLE, FOR A GEAR MOTOR, AN ELECTRIC MOTOR, OR A TRANSMISSION

(71) Applicant: SEW-EURODRIVE GMBH & CO. KG, Bruchsal (DE)

(72) Inventor: Li JINCHANG, Tianjin (CN)

(73) Assignee: SEW-EURODRIVE GMBH & CO. KG, Bruchsal (DE)

(21) Appl. No.: 19/144,582

(22) PCT Filed: Nov. 15, 2023
(86) PCT No.: PCT/EP2023/025483

§ 371 Date: Jun. 30, 2025

(30) Foreign Application Priority Data
Dec. 30, 2022 (CN) 202211719054.4
Apr. 5, 2023 (DE) 102023001354.4

(51) Int. Cl. F16C 35/04; F16C 19/06; F16C 33/78; H02K 5/173

(52) U.S. Cl. CPC F16C 35/045; F16C 19/06; F16C 33/7896; H02K 5/173; F16C 2380/28

(57) ABSTRACT

A bearing assembly includes a shaft, a flange part, and a bearing which is received in the flange part for the rotatable supporting the shaft. The flange part is arranged to be hollow, and the shaft protrudes through the flange part in the axial direction and/or out of the flange part on both sides. The flange part has an annular bearing receiving region, a flange region, and a tubular region which is connected to the bearing receiving region and to the flange region. The tubular region is equipped with ribs which protrude radially outwards and which are mutually spaced in the circumferential direction, the ribs extending from the bearing receiving region to the flange region in the axial direction.

### FIELD OF THE INVENTION

The present invention relates to a bearing assembly, e.g., for an electric motor or for a transmission, and to an electric motor with a bearing assembly.

### BACKGROUND INFORMATION

In certain contention systems, it is provided to support a shaft via a bearing.

### SUMMARY

Example embodiments of the present invention is to provide an improved bearing assembly.

According to an example embodiment of the present invention, a bearing assembly, e.g., for an electric motor or for a transmission, includes a shaft, a flange part, and a bearing which is received in the flange part for rotatably supporting the shaft. The flange part is arranged to be hollow, and the shaft protrudes through the flange part in the axial direction and/or out of the flange part on both sides. The flange part has an annular bearing receiving region, a flange region, and a tubular region which is connected to the bearing receiving region and to the flange region. The tubular region is equipped with ribs which protrude radially outwards and which are mutually spaced, e.g., regularly, in the circumferential direction, the ribs extending from the bearing receiving region to the flange region in the axial direction.

An advantage of this is that the tubular region can be arranged to be elongated. For example, the tubular region is axially extended further than the clear inside diameter of the bearing mount, e.g., than the clear inside diameter of the bearing receiving region. This makes it difficult for lubricant to penetrate in the direction of the stator because the annular gap between the shaft and the tubular region, which gap is arranged to be as long as possible axially, can be arranged to be very narrow. This improves safety against oil. Additionally, the second shaft sealing ring seals. A bearing, which supports the shaft in a rotatable manner, can be received in the bearing mount.

According to example embodiments, the flange region is formed in the shape of a perforated disk. An advantage of this is that the shaft can be arranged protruding through the flange region and the tubular region as well as through the bearing receiving region.

According to example embodiments, the tubular region is equipped with ribs which protrude radially outwards and which are mutually spaced, e.g., regularly, in the circumferential direction, the ribs extending from the bearing receiving region to the flange region in the axial direction. An advantage of this is the improved rigidity and heat dissipation. This means that an electric motor including the bearing assembly has improved heat dissipation.

According to example embodiments, the flange part is formed in one piece and/or in one part with the bearing receiving region, the flange region and the tubular region including the ribs. An advantage of this is that it is readily produced as a cast part, e.g., a die-cast part.

According to example embodiments, the tubular region is formed widened towards the flange region. An advantage of this is that the outer diameter of the flange region can be selected to be very large, thus improving the accessibility of the inlet.

According to example embodiments, further ribs are formed on the inside of the flange part. An advantage of this is that improved heat absorption and thus heat dissipation is possible.

According to example embodiments, the region covered by the further ribs in the axial direction includes the region covered by the flange part in the axial direction. An advantage of this is that the further ribs can be provided as inner ribs in the widened region, thus allowing for improved heat dissipation.

According to example embodiments, the further ribs are delimited radially inwards by a radial distance which is greater than the radial distance of the inner wall of the bearing receiving region, e.g., of the bearing seat of the bearing in the bearing receiving region. An advantage of this is that the shaft can be routed through the flange part.

According to example embodiments, the flange part has an axially protruding annular collar on the side of the flange region axially facing away from the bearing receiving region, on the outer circumference of which annular collar are formed bump regions 33 which are mutually spaced in the circumferential direction, e.g., regularly, and protrude in the radial direction, in each of which bump regions 33 an axial bore is made, e.g., for connection to a cuboid stator of an electric motor. An advantage of this is that a cuboid stator can be connected even though the annular collar formed in a hollow cylindrical manner. This means that the hole pattern for fastening screws, which are screwed into the axial holes, can be arranged radially outside the annular collar.

According to example embodiments, the bearing assembly has a first shaft sealing ring and a second shaft sealing ring. The first shaft sealing ring seals towards the shaft, e.g., in that a sealing lip of the first shaft sealing ring touches the shaft and/or runs off a first sealing seat of the shaft, e. g., which sealing seat is machined by grinding. The second shaft sealing ring seals towards the shaft, e.g., in that a sealing lip of the second shaft sealing ring touches the shaft and/or runs off a second sealing seat of the shaft, e.g., which sealing seat is machined by grinding. The first shaft sealing ring is spaced from the second shaft sealing ring in the axial direction, e.g., in the direction of the axis of rotation of the shaft. The bearing is arranged in the axial direction between the first shaft sealing ring and the second shaft sealing ring. The flange part has a first recess passing through the flange part for the supply of lubricant. The flange part has a second recess passing through the flange part for removing, e.g., for discharging, lubricant. The first recess is spaced from the second recess in the circumferential direction, and, for example, the first recess is arranged diametrically opposite the second recess in the circumferential direction.

An advantage of this is that a spatial region can be filled with lubricant, e.g., a lubricant arranged as an oil-air mixture, and a bearing is arranged in the spatial region, which bearing can be supplied with the lubricant. The shaft sealing rings seals off from the environment. This means that an electric motor can be equipped with an oil-lubricated bearing assembly on the A-side and thus the rotor shaft of the electric motor can be supported with low power loss. The flange part is thus arranged as a bearing flange with an integrated oil-filled spatial region so that the bearing can be lubricated with oil, although no oil must enter the interior of the motor. For this reason, an axially elongated annular gap is also arranged between the bearing and the second shaft sealing ring, making it difficult for oil to reach the second shaft sealing ring. Additional inner grooves provide a collection point for oil, e.g., oil thrown off the shaft.

According to example embodiments, the first shaft sealing ring is received in a bearing cover, which is tightly connected to the flange part, e.g., via a flat seal arranged between the flange part and the bearing cover. An advantage of this is that the spatial region including the bearing is sealed off from the environment.

According to example embodiments, the first shaft sealing ring is received in the flange part. An advantage of this is that the spatial region including the bearing is sealed off from the environment and can thus be filled with oil. In this manner, power loss can be reduced.

According to example embodiments, the second shaft sealing ring is received in the flange part. An advantage of this is that the region including the bearing is sealed off towards the interior of the electric motor. This prevents oil from entering the interior of the motor.

According to example embodiments, the first recess is arranged on the side of the bearing axially facing away from the first shaft sealing ring and the second recess is arranged on the side of the bearing axially facing the first shaft sealing ring. An advantage of this is that the lubricant is let in on the first axial side of the bearing and let out on the other axial side of the bearing. The lubricant must thus penetrate the bearing, e.g., if the lubricant is arranged as a mixture.

According to example embodiments, an annular spatial region is delimited by the bearing flange, the flange part, the first shaft sealing ring, the second shaft sealing ring, and the shaft and is sealed off from the outer environment of the bearing assembly via the first shaft sealing ring. An advantage of this is that a lubricant, which is a liquid such as oil, can be applied to the spatial region. Via the shaft sealing rings, however, the chamber region is sealed off from the environment, e.g., from both the external environment and the interior of the electric motor.

According to example embodiments, the bearing, e.g., a roller bearing, e.g., a ball bearing, is arranged in the spatial region. An advantage of this is that efficient lubrication can be achieved via the lubricant. For example, the proportion of air in the lubricant can be optimized. Friction losses can thus be reduced.

According to example embodiments, the first recess opens into the annular spatial region, e.g., coming from the outer environment. An advantage of this is that lubricant is readily supplied.

According to example embodiments, the second recess opens into the annular spatial region, e.g., coming from the outer environment. An advantage of this is that lubricant can be discharged, e.g., in the event of overpressure. For example, the second recess is arranged below the first recess in the direction of gravity.

According to example embodiments, the lubricant is an oil-air mixture. The advantage of this is that the power loss can be reduced and efficient, optimized lubrication is possible.

According to example embodiments, a radially protruding flange region is formed on the flange part, which flange region has a through-bore that acts as an inlet for the lubricant. A pipeline leads from the inlet to the first recess. An advantage of this is that the flange region transmits a high reactive torque and the inlet can be arranged at a large radial distance and is thus readily accessible.

According to example embodiments, the inlet is arranged at a greater radial distance than the first and second recess, and the inlet is spaced from the first recess and from the second recess in the axial direction. For example, the flange region protrudes radially further than the connection region and/or axially between the flange region and the connection region the flange part has a smaller outer diameter than in the flange region and than in the connection region.

An advantage of this is that the inlet is readily accessible. This means that an external hose is readily accessible and readily connected from the motor side. The flange part is arranged to be narrowed from the inlet to the connection region. This narrowing can be bridged via a pipeline that can be connected during manufacture of the electric motor. An external hose can thus be readily connected and readily accessible, since it is connected from the motor side and not from the load side.

According to example embodiments, the spatial region axially between the bearing and the second shaft sealing ring has an annular gap which is axially bordered on both sides by a free space delimited by an inner groove of the flange part. An advantage of this is that respectively an oil drain bore, which is, for example, thin, can be provided as an option, which oil drain bore is respectively arranged to pass through the flange part and opens into a respective one of the two free spaces. This allows any accumulated oil to flow off before it comes into contact with the second shaft sealing ring. An annular gap which is arranged to be as long as possible in the axial direction prevents the oil from reaching the second shaft sealing ring, or at least the amount of oil reaching the second shaft sealing ring is only minimal. This is because the oil flows into the nearest inner groove before it builds up dangerously high on the second shaft sealing ring.

According to example embodiments, the maximum radial width of the annular gap is smaller than the maximum radial width of the respective free space. An advantage of this is that flow through the annular gap is prevented or at least reduced.

According to example embodiments, the inner ring of the bearing is set axially against a step of the shaft on the one side and is axially delimited by a retaining ring embedded in an annular groove of the shaft on the other side. An advantage of this is that the bearing can be arranged as a fixed bearing.

According to example embodiments, the outer ring of the bearing is set axially against a step of the flange part on the one side and is axially delimited by the bearing cover on the other side. An advantage of this is that the bearing can be arranged as a fixed bearing.

According to example embodiments, in an electric motor that includes a bearing assembly, the shaft is arranged as the rotor shaft of the electric motor, e.g., the shaft is the rotor shaft of the electric motor. For example, the flange part is connected to a stator housing of the electric motor, which stator housing, on the side axially facing away from the flange part, is connected to a bearing shield, in which a further bearing is received for rotatably supporting the shaft.

An advantage of this is that the bearing assembly can be arranged on an electric motor and thus the losses due to the oil lubrication of the bearing of the bearing assembly can be reduced.

Further features and aspects of example embodiments of the present invention are explained in more detail below with reference to the appended schematic Figures.

### BRIEF DESCRIPTION OF THE DRAWINGS

FIG. 1 is a cross-sectional view of a bearing assembly.

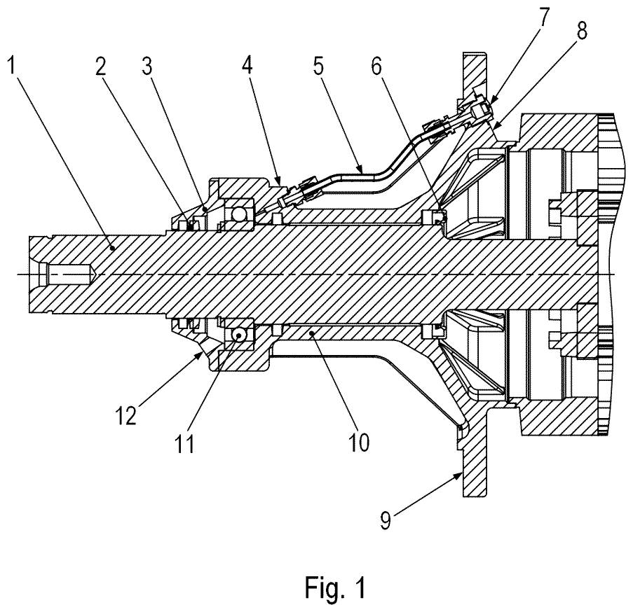

FIG. 2 is a perspective view of a flange part 10 in a first viewing direction.

FIG. 3 is a perspective view of the flange part 10 in a second viewing direction.

### DETAILED DESCRIPTION

As illustrated in the Figures, the bearing assembly has a flange part 10, e.g., a bearing flange, in which a bearing 11 is received for rotatably supporting a shaft 1.

A bearing cover 3 is connected to the flange part 10 and covers the bearing towards the external environment. A flat seal is, for example, provided between the bearing cover 3 and the flange part 10 to ensure a tight connection.

A first shaft sealing ring 2 is received in the bearing cover 3, which shaft sealing ring 2 seals towards the shaft 1.

On the side of the bearing 11 axially facing away from the first shaft sealing ring 2, a second shaft sealing ring 6 is received in the flange part 10, which shaft sealing ring 6 seals towards the shaft 1.

This creates a sealed spatial region around the bearing 11 into which lubricating oil can be let in, which lubricates the bearing 11.

The spatial region is thus delimited by the bearing cover 3, the flange part 10, the first shaft sealing ring 2, and the second shaft sealing ring 6 as well as the shaft 1.

An outlet 12 is provided to prevent overpressure in this spatial region.

The outlet 12 is arranged on the bottom side of the flange part 10. A connection region 4 is arranged on the top side of the flange part 10.

A radially protruding flange region 9 is also formed on the flange part 10, on which flange region 9 an inlet 7 is arranged.

The flange region 9 is spaced from the connection region 4 in the axial direction. For example, the flange region 9 protrudes radially on the flange part 10, e.g., further than the connection region 4.

Axially between the flange region 9 and the connection region 4, the flange part 10 has a smaller outer diameter than in the flange region 9 and also than in the connection region 10.

A pipeline 5 is connected to the connection region 4, which pipeline 5 is routed to an inlet 7 formed on the flange region 9. This inlet 7 is arranged at a greater radial distance than the connection region 4. This provides improved accessibility for connecting a supply line.

The radial distance is related to the axis of rotation of the shaft 1. The circumferential direction is also related to the axis of rotation of the shaft 1. The axial direction is aligned parallel to the axis of rotation of the shaft 1.

An air-oil mixture is fed to the bearing 11 through the inlet 7 and the pipeline 5. This air-oil mixture is produced by injecting oil droplets into an air flow via an oil mixing device, and the oil mixing device builds up the oil-air mixture with a corresponding pressure so that it is then conveyed to the pipeline. The oil-air mixture is pressed through the pipeline 5, which is so narrow, however, and for example, has such a small internal diameter, that oil droplets are arranged in the pipeline 5 mutually spaced one behind the other, and air is respectively arranged between the oil droplets in the direction of the pipeline 7.

The oil-air mixture passes from the pipeline 5 to the bearing 11 and travels as a mist towards the bearing 11, where the mist is deposited and thus lubricates the roller bodies of the bearing 11.

The speed of the oil-air mixture can be controlled at the inlet 7 and/or via the pressure built up by the mixing device, and the mixing device feeds the inlet 7. This means that flow-related losses and/or losses caused by high lubrication quantities can be avoided.

### The spatial region also has an annular gap between the flange part 10 and the shaft 1, and the annular gap 10 is arranged axially between the bearing 11 and the shaft sealing ring 6.

The radial width of the annular gap has a constant region which is axially bordered on both sides by a free space delimited by an inner groove of the flange part 10.

For example, a toothed part is connected to the shaft 1 for conjoint rotation and the bearing assembly is comprised by an electric motor, in which the shaft 1 is the rotor shaft of the electric motor, or is included by a transmission, in which the shaft 1 is the driving shaft of the transmission.

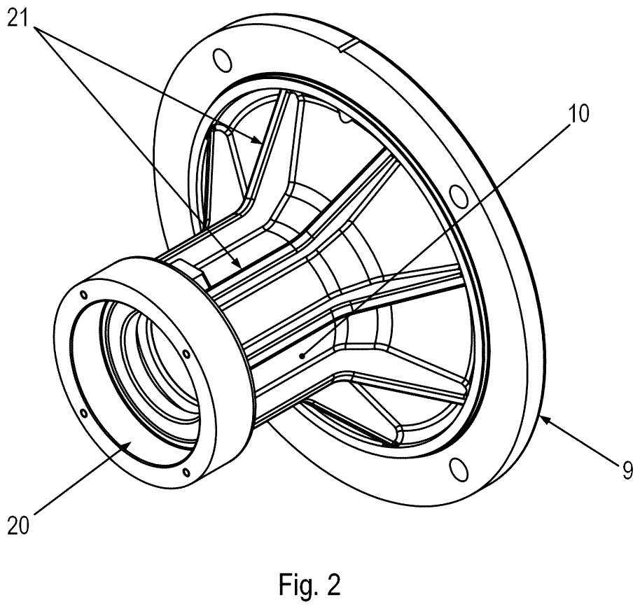

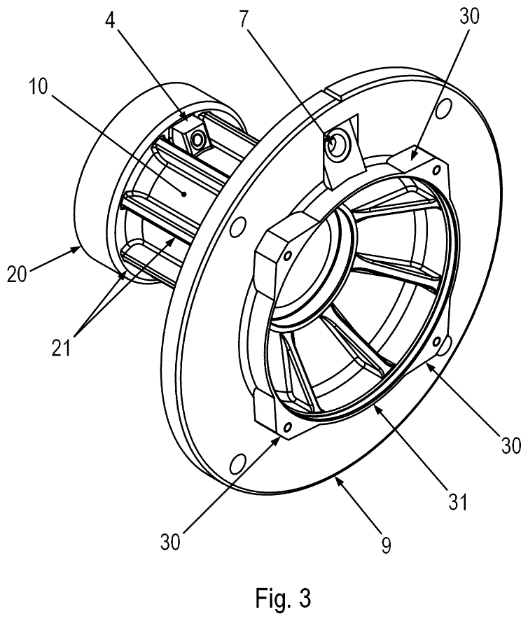

As illustrated in FIGS. 2 and 3, the flange part 10 has an annular bearing receiving region 20, the radial wall thickness of which is greater than the radial wall thickness of the flange part 10 in the region of the flange part 10 adjacent to the bearing receiving region 20.

Axially spaced from the bearing receiving region 20 is a flange region 9 whose radial wall thickness is also greater than in the region of the flange part 10 adjacent to the bearing receiving region 20 and/or to the flange region 9, which region is tubular in shape and connects the flange region 9 to the bearing receiving region 20.

On the outer circumference of the tubular region, radially outwardly protruding ribs 21 extending in an axial direction are formed, which increase the surface region and thus improve heat dissipation and also improve the rigidity of the flange part 10.

On the side of the flange region 9 that is axially facing away from the bearing receiving region 20, the flange part 10 has an axially protruding annular collar 31, on the outer circumference of which there are bump regions 33 which are mutually spaced in the circumferential direction, e.g., regularly, and protrude in the radial direction, each of which has an axial bore. This means that a cuboid stator of the electric motor can be connected via screw parts, threaded rods, or screws screwed into the bores.

The ribs 21 are mutually spaced in the circumferential direction, e.g., regularly.

Since the annular collar 31 has a smaller outer diameter than the flange region 9, the flange region projects beyond the annular collar 31 and also the bump regions 30 in a radial direction.

The tubular region, for example, also has further ribs on its inside that extend axially and protrude radially inwards, so that stability and heat dissipation are improved. For example, the cooling of the stator winding of the electric motor is improved by the additional ribs projecting radially inwards.

The region covered by the further ribs in the axial direction includes the region covered by the flange region 9 in the axial direction. For example, this region can thus be made more rigid and improved heat dissipation can be achieved.

The further ribs are delimited radially inwards by a radial distance that is greater than the radial distance of the bearing mount.

The tubular region is widened towards the flange region.

The inlet 7 is formed on the flange region 9. The connection region 4 is formed on the bearing receiving region 20.

For example, a second bearing is arranged within the spatial region, which is thus also lubricated by the oil-air mixture.

### LIST OF REFERENCE NUMERALS

1 Shaft
2 Shaft sealing ring
3 Bearing cover
4 Connection region
5 Pipeline
6 Shaft sealing ring
7 Inlet
8 Connection region
9 Flange region, annular
10 Flange part, e.g., bearing flange
11 Bearing
12 Outlet
20 Bearing receiving region
21 Ribs
30 Bump regions
31 Annular collar

1-15. (canceled)

16. A bearing assembly, comprising:
a shaft;
a hollow flange part, the shaft protruding through the flange part in an axial direction and/or out of the flange part on both sides; and
a bearing received in the flange part and rotatably supporting the shaft;
wherein the flange part includes an annular bearing receiving region, a flange region, and a tubular region connected to the bearing receiving region and to the flange region;
wherein the tubular region includes ribs that protrude radially outwardly and that are mutually spaced in a circumferential direction, the ribs extending from the bearing receiving region to the flange region in the axial direction.

17. The bearing assembly according to claim 16, wherein the flange region is arranged as a perforated disk, and the ribs are spaced regularly in the circumferential direction.

18. The bearing assembly according to claim 16, wherein further ribs are arranged on an inside of the flange part.

19. The bearing assembly according to claim 16, wherein the tubular region widens toward the flange region, the flange part is arranged in one piece and/or in one part with the bearing receiving region, the flange region, and the tubular region including the ribs.

20. The bearing assembly according to claim 18, wherein a region covered by the further ribs in the axial direction includes a region covered by the flange part in the axial direction.

21. The bearing assembly according to claim 20, wherein the further ribs are delimited radially inwardly by a radial distance that is greater than a radial distance of an inner wall of the bearing receiving region and/or a bearing seat of a bearing in the bearing receiving region.

22. The bearing assembly according to claim 16, wherein the flange part has an axially protruding annular collar on a side of the flange region axially facing away from the bearing receiving region, on an outer circumference of which annular collar are formed bump regions mutually spaced in the circumferential direction and protrude in a radial direction, each bump region including an axial bore.

23. The bearing assembly according to claim 16, further comprising a first shaft sealing ring and a second shaft sealing ring, wherein the first shaft sealing ring seals towards the shaft, the second shaft sealing ring seals towards the shaft, the first shaft sealing ring is spaced from the second shaft sealing ring in the axial direction, the bearing is arranged in the axial direction between the first shaft sealing ring and the second shaft sealing ring, the flange part has a first recess passing through the flange part and adapted to supply lubricant, the flange part has a second recess passing through the flange part and adapted to remove the lubricant, and the first recess is spaced from the second recess in the circumferential direction.

24. The bearing assembly according to claim 23, wherein the first shaft sealing ring is received in a bearing cover connected to the flange part, or the first shaft sealing ring is received in the flange part.

25. The bearing assembly according to claim 23, wherein the second shaft sealing ring is received in the flange part.

26. The bearing assembly according to claim 23, wherein the first recess is arranged on a side of the bearing axially facing away from the first shaft sealing ring, and the second recess is arranged on a side of the bearing axially facing the first shaft sealing ring.

27. The bearing assembly according to claim 23, wherein an annular spatial region is delimited by the bearing flange, the flange part, the first shaft sealing ring, the second shaft sealing ring, and the shaft and is sealed off from the external environment of the bearing assembly by the first shaft sealing ring.

28. The bearing assembly according to claim 27, wherein the bearing is arranged in the spatial region, the first recess opens into the annular spatial region, the second recess opens into the annular spatial region, and/or the lubricant includes an oil-air mixture.

29. The bearing assembly according to claim 23, wherein a radially protruding flange region is formed on the flange part and includes a through-bore that arranged as a lubricant inlet, and a pipeline leads from the inlet to the first recess.

30. The bearing assembly according to claim 29, wherein the inlet is arranged at a greater radial distance than the first and second recesses, and the inlet is spaced from the first recess and from the second recess in the axial direction.

31. The bearing assembly according to claim 30, wherein the flange region protrudes radially further than a connection region, and/or axially between the flange region and the connection region, the flange part has a smaller outer diameter than in the flange region and then in the connection region.

32. The bearing assembly according to claim 23, wherein a spatial region axially between the bearing and the second shaft sealing ring has an annular gap that is axially bordered on both sides by a free space delimited by an inner groove of the flange part.

33. The bearing assembly according to claim 32, wherein a maximum radial width of the annular gap is smaller than a maximum radial width of the respective free space.

34. The bearing assembly according to claim 16, an inner ring of the bearing is set axially against a step of the shaft on a first side and is axially delimited by a retaining ring embedded in an annular groove of the shaft on a second opposite side.

35. The bearing assembly according to claim 16, wherein an outer ring of the bearing is set axially against a step of the flange part on a first side and is axially delimited by the bearing cover on a second opposite side.

36. An electric motor, comprising:
the bearing assembly as recited in claim 16, wherein the shaft is arranged as a rotor shaft of the electric motor.

37. The electric motor according to claim 36, wherein the flange part is connected to a stator housing of the electric motor, and the stator housing, on a side axially facing away from the flange part, is connected to a bearing shield, in which a further bearing is received and rotatably supports the shaft.
